(19) United States
(12) Patent Application Publication
(10) Pub. No.: US 2026/0032445 A1
(43) Pub. Date: Jan. 29, 2026

(54) PERMANENT IDENTIFIER BASED SECURITY FOR REMOTE UES IN MOBILE NETWORKS

(71) Applicant: Palo Alto Networks, Inc., Santa Clara, CA (US)

(72) Inventors: Sachin Verma, Danville, CA (US); Leonid Burakovsky, Pleasanton, CA (US)

(21) Appl. No.: 18/784,438

(22) Filed: Jul. 25, 2024

(51) Int. Cl. H04W 12/37

(52) U.S. Cl. CPC H04W 12/37

(57) ABSTRACT

Various techniques for permanent identifier based security for remote User Equipment devices (UEs) in mobile networks are disclosed. Specifically, new and improved techniques for permanent identifiers for applying intelligent security for remote UEs in mobile networks (e.g., a UE-to-Network Relay in a 5G network or a 4G/LTE network) that uses Proximity-based services (ProSe) are disclosed. In an example implementation, a security platform is deployed in the mobile network. The security platform is configured to inspect control signaling traffic (e.g., GTP control signaling traffic). More specifically, the security platform collects remote UE identities including, for example, IMSI, IMEI, MSISDN, and IP address information, to provide visibility and enforcement capabilities for remote UEs that are not directly connected to the mobile network.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRA WINGS

Various embodiments of the invention are disclosed in the following detailed description and the accompanying drawings.

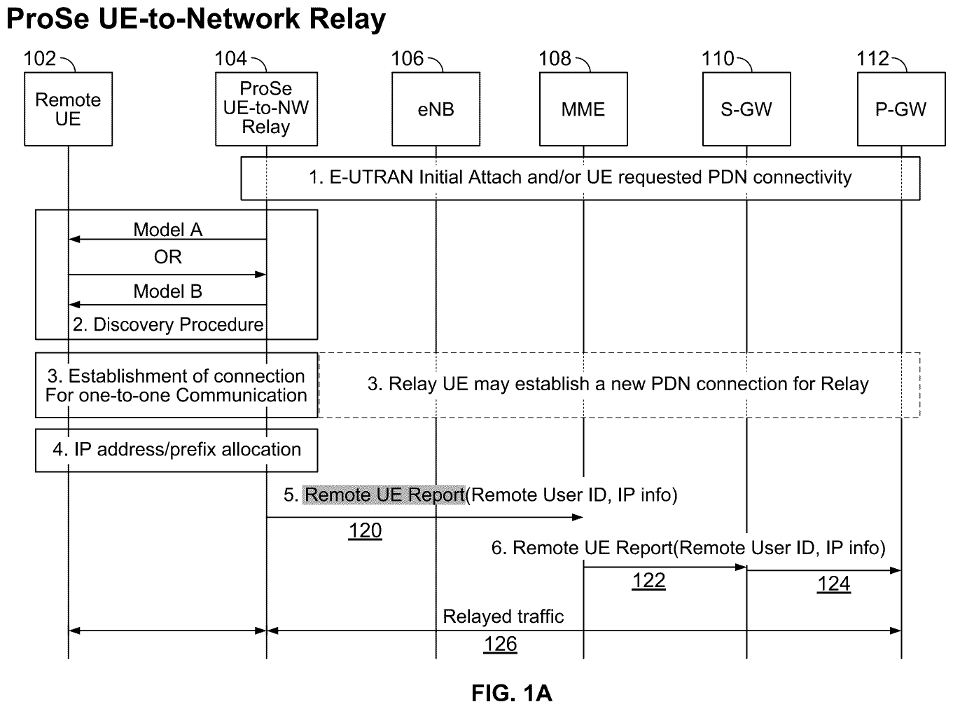

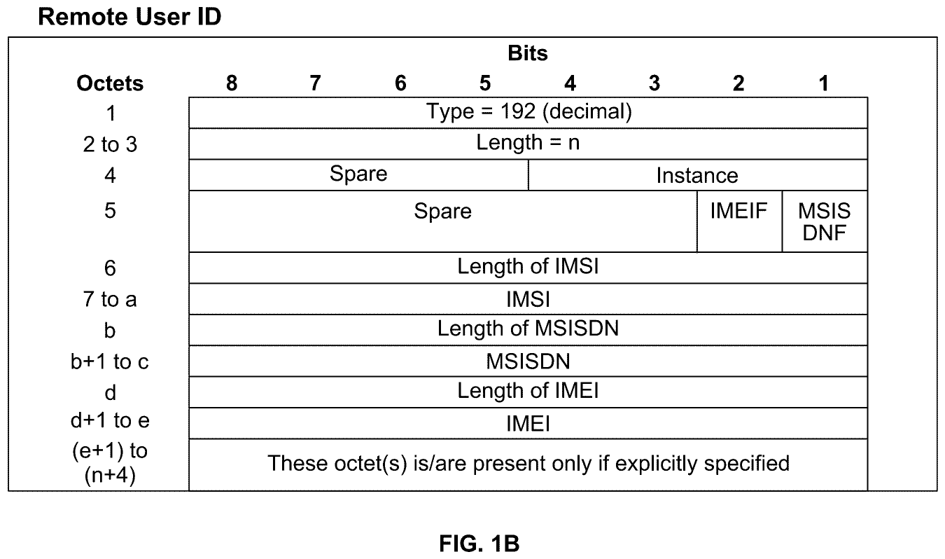

FIG. 1A is a protocol sequence diagram of a ProSe UE-to-Network Relay in a 4G/LTE mobile network environment in accordance with some embodiments.

FIG. 1B is a data structure diagram of a Remote User ID for a ProSe UE-to-Network Relay in a 4G/LTE mobile network environment in accordance with some embodiments.

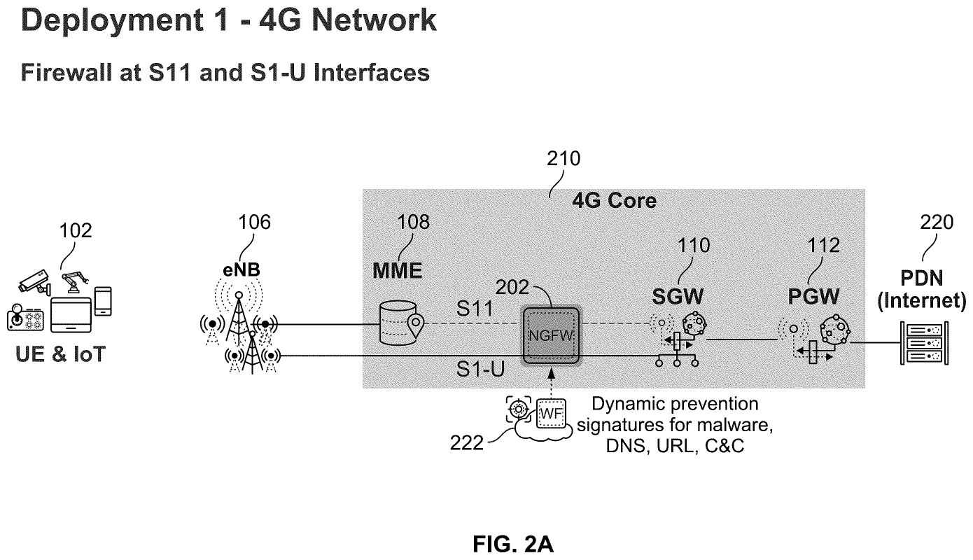

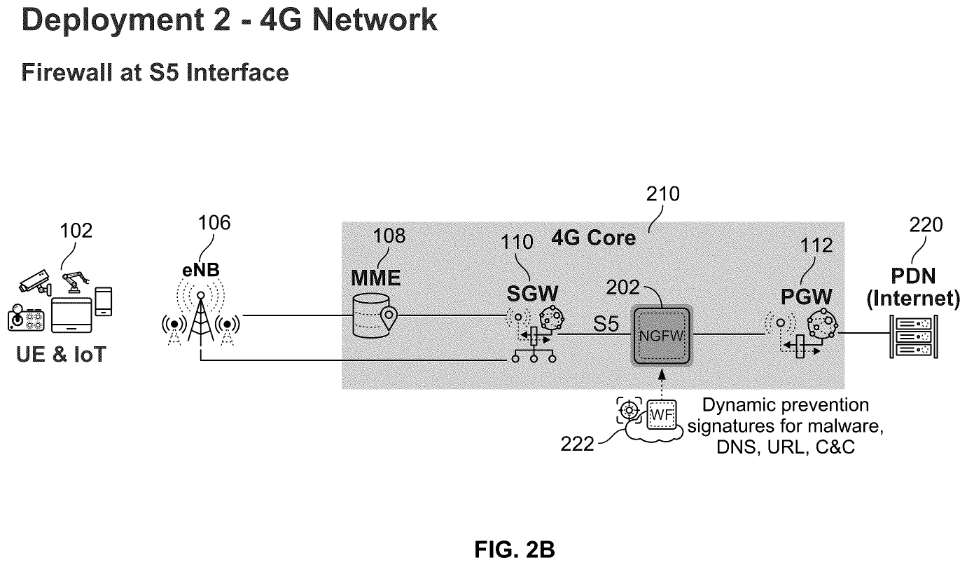

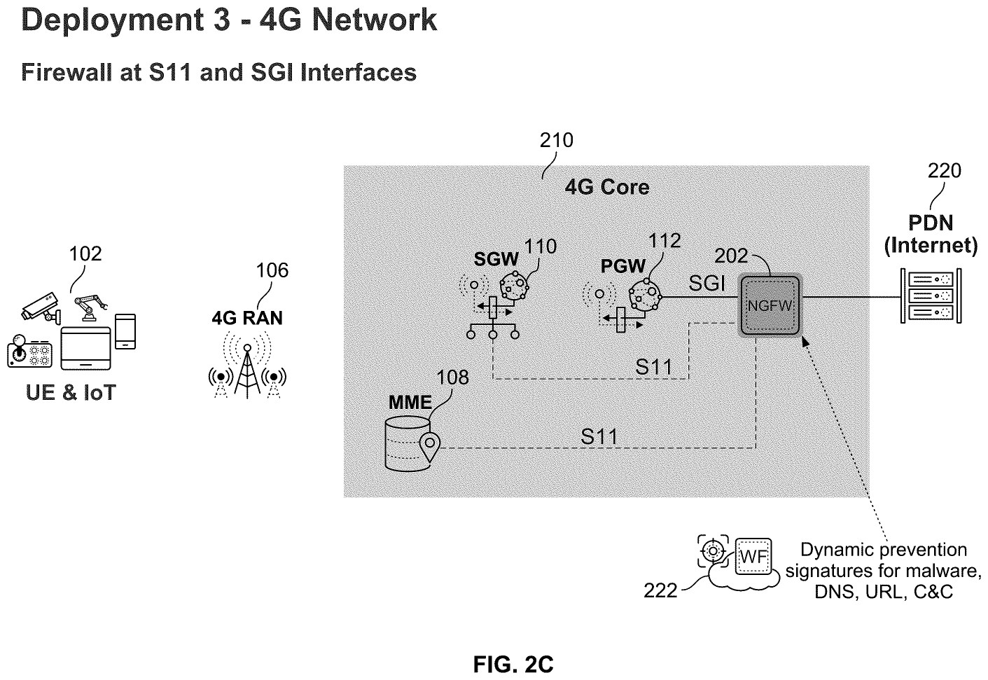

FIG. 2A is a block diagram of a first example deployment architecture of a security platform in a 4G/LTE wireless network environment for permanent identifier based security for remote UEs in mobile networks in accordance with some embodiments.

FIG. 2B is a block diagram of a second example deployment architecture of a security platform in a 4G/LTE wireless network environment for permanent identifier based security for remote UEs in mobile networks in accordance with some embodiments.

FIG. 2C is a block diagram of a third example deployment architecture of a security platform in a 4G/LTE wireless network environment for permanent identifier based security for remote UEs in mobile networks in accordance with some embodiments.

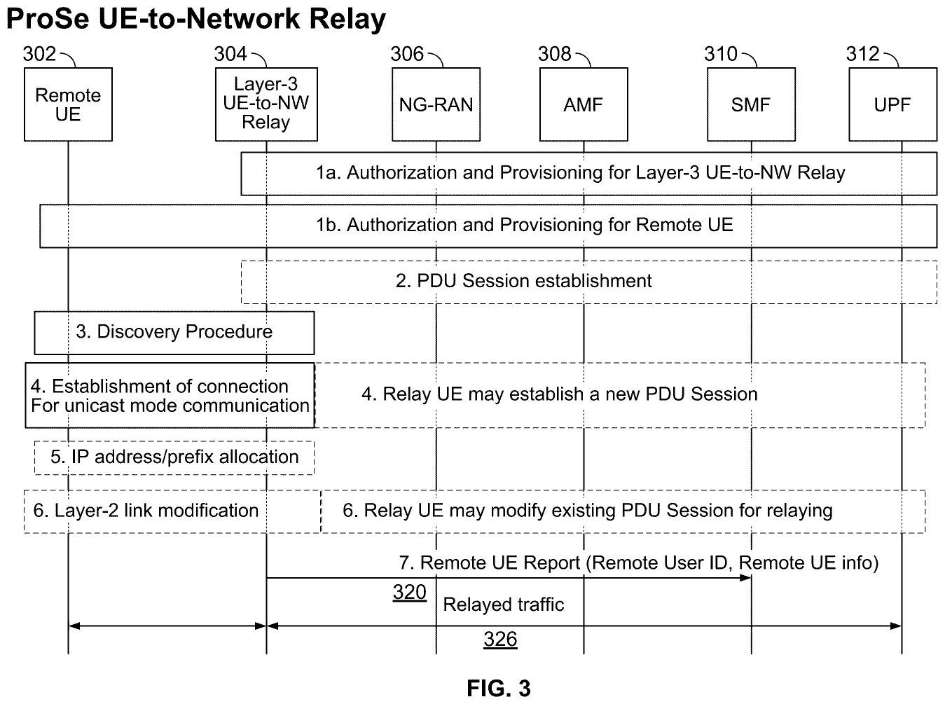

FIG. 3 is a protocol sequence diagram of a ProSe UE-to-Network Relay in a 5G mobile network environment with enhanced security in accordance with some embodiments.

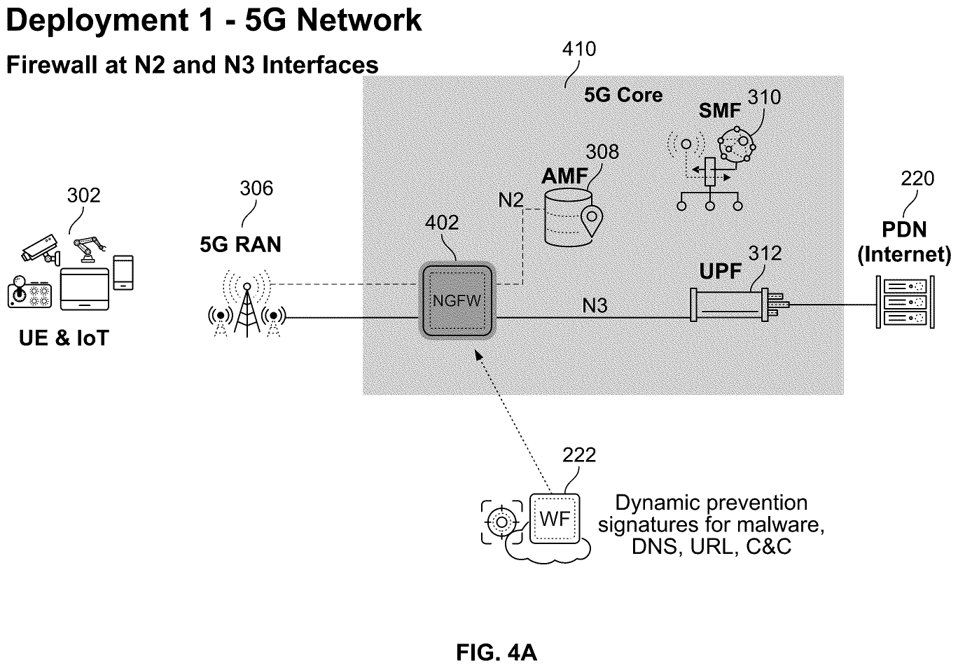

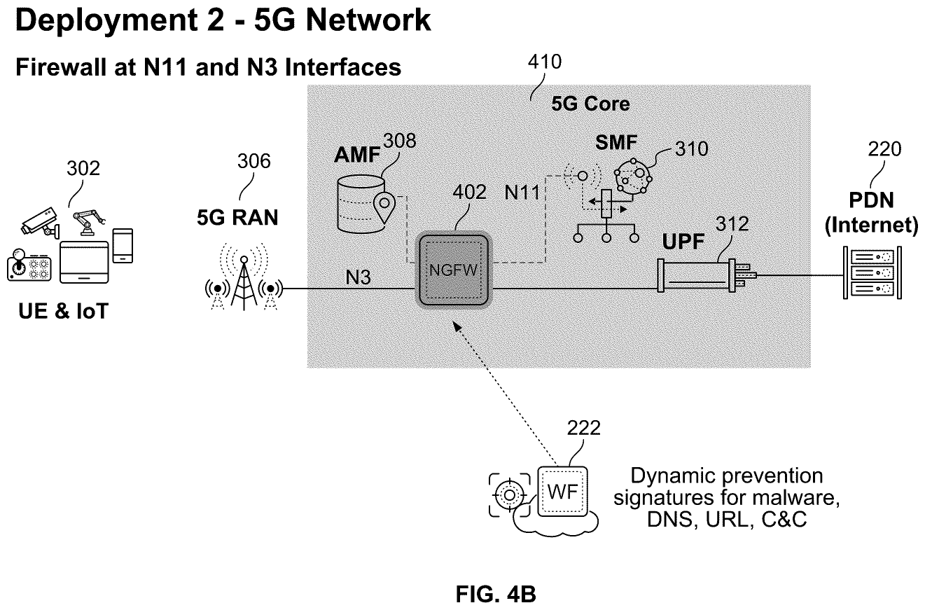

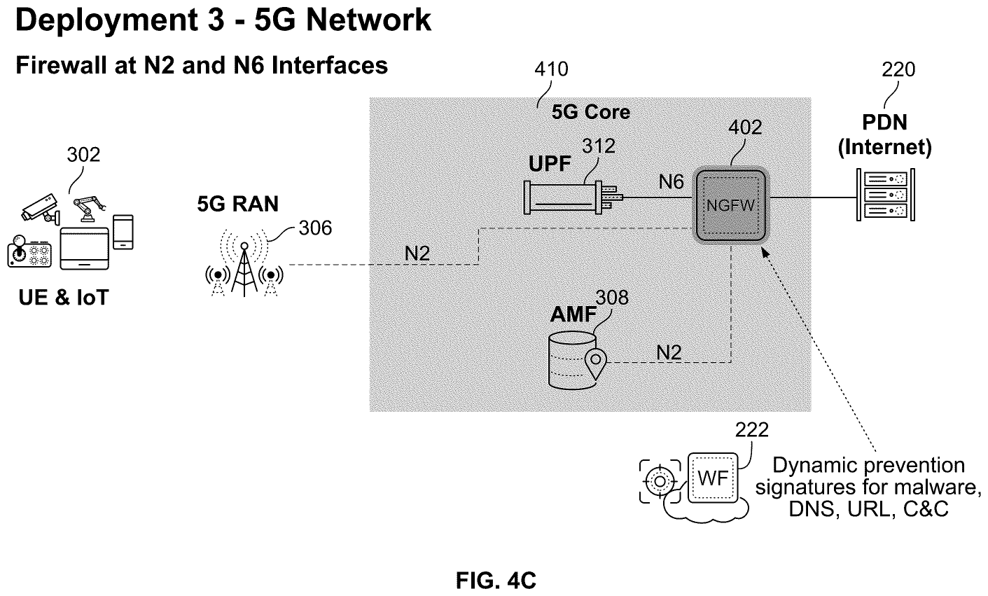

FIG. 4A is a block diagram of a first example deployment architecture of a security platform in a 5G wireless network environment for permanent identifier based security for remote UEs in mobile networks in accordance with some embodiments.

FIG. 4B is a block diagram of a second example deployment architecture of a security platform in a 5G wireless network environment for permanent identifier based security for remote UEs in mobile networks in accordance with some embodiments.

FIG. 4C is a block diagram of a third example deployment architecture of a security platform in a 5G wireless network environment for permanent identifier based security for remote UEs in mobile networks in accordance with some embodiments.

FIG. 4D is a block diagram of a fourth example deployment architecture of a security platform in a 5G wireless network environment for permanent identifier based security for remote UEs in mobile networks in accordance with some embodiments.

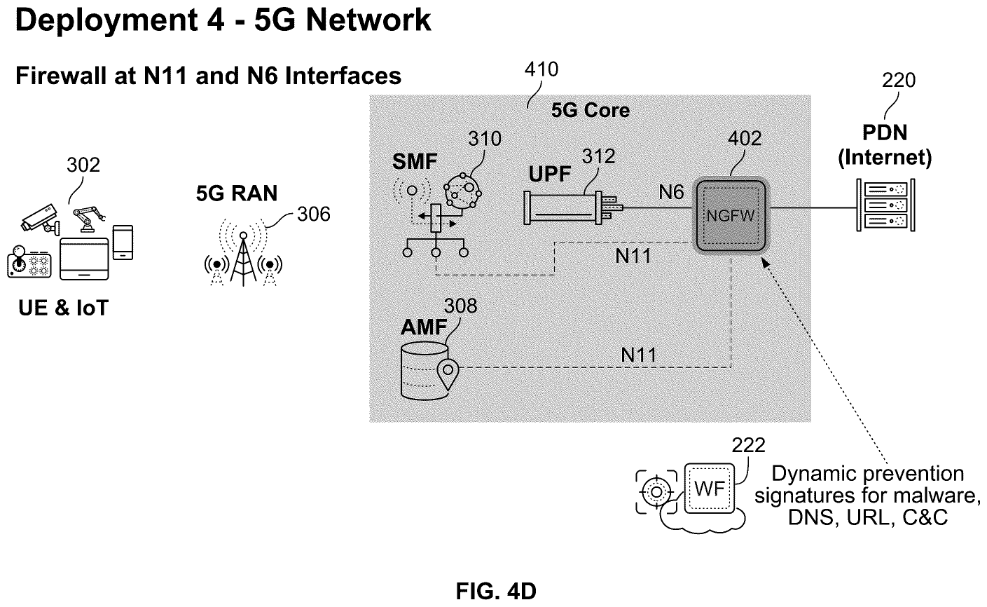

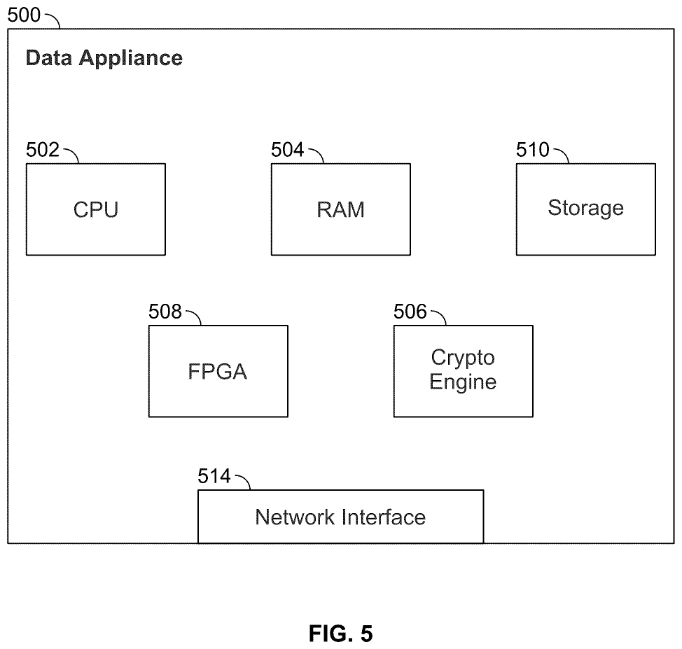

FIG. 5 is a functional diagram of hardware components of a network device for permanent identifier based security for remote UEs in mobile networks in accordance with some embodiments.

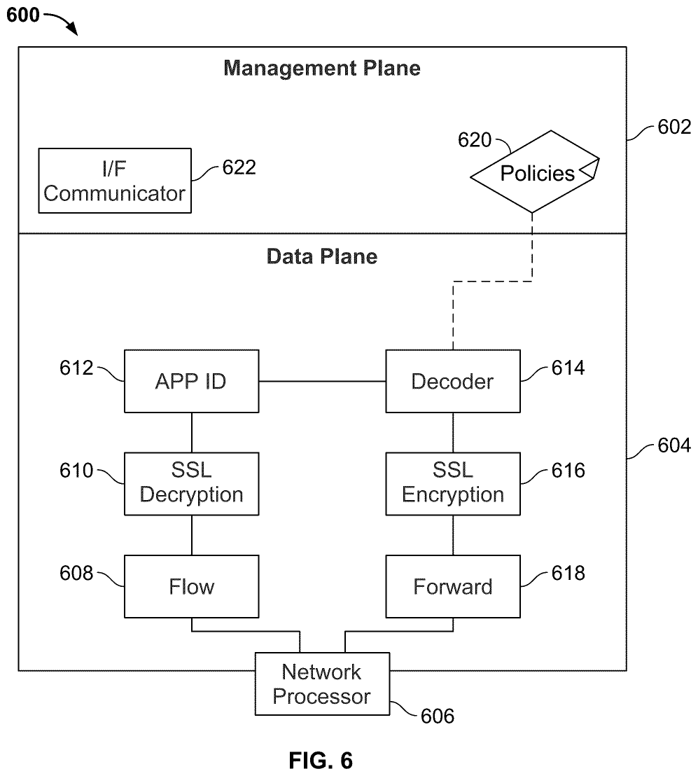

FIG. 6 is a functional diagram of logical components of a network device for permanent identifier based security for remote UEs in mobile networks in accordance with some embodiments.

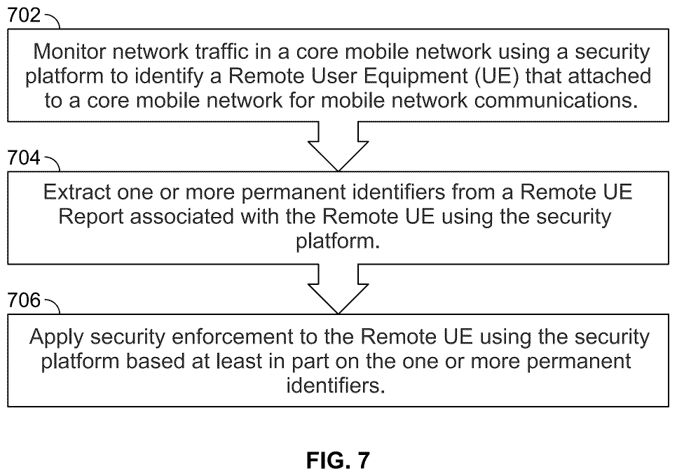

FIG. 7 is a flow diagram of a process for permanent identifier based security for remote UEs in mobile networks in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QOS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

### Overview of Techniques for Permanent Identifier Based Security for Remote User Equipment Devices (UEs) in Mobile Networks

Proximity-based services (ProSe) is a 3GPP (e.g., ETSI standards organization) specified technology (e.g., for more details refer to the 3GPP T.S 23.303 v17.1.0 specification, which is publicly available at https://www.ctsi.org/deliver/etsi_ts/123300_123399/123303/17.01.00_60/ts_123303v170100p.p df), which allows a User Equipment (UE) like a smartphone, cellular IoT device, or another cellular enabled device to discover other UEs that are within close proximity while off-network. A ProSe-enabled UE within network coverage can act as a relay for nearby devices that are outside of the cellular network coverage.

Example ProSe features include (1) ProSe discovery (e.g., direct or EPC-level); and (2) ProSe Direct Communication. ProSe discovery identifies that ProSe-enabled UEs are in proximity, using E-UTRAN (e.g., with or without E-UTRAN), WLAN technology, or EPC. ProSe Direct Communication enables the establishment of communication paths between two or more ProSe-enabled UEs that are in direct communication range. The ProSe Direct Communication path can use E-UTRAN or WLAN.

For example, the ProSe technology can be used for various commercial and/or public safety use cases. For Public Safety specific usage, ProSe-enabled Public Safety UEs can establish the communication path directly between two or more ProSe enabled Public Safety UEs, regardless of whether the ProSe-enabled Public Safety UE is served by E-UTRAN. ProSe Direct Communication is also facilitated by the use of a ProSe UE-to-Network Relay, which acts as a relay between E-UTRAN and UEs.

However, security platforms/solutions (e.g., NGFWs, proxies, routers, cloud-based security solutions, and/or other similar devices/solutions for providing various types of security enforcement) are unable to identify the subscriber or equipment identity for UEs that have Proximity-based services (ProSe) enabled and communicate like remote UEs via a UE-to-Network Relay in a 4G/LTE or 5G network. As such, this presents a technical challenge for using such security platforms/solutions to effectively apply identity-based security enforcement and logging on traffic to/from such remote UEs (e.g., using the 4G/LTE or 5G mobile networks via a UE-to-Network Relay).

Thus, what is needed are improved techniques for applying security for remote UEs in mobile networks that use Proximity-based services (ProSe).

Accordingly, new and improved techniques for permanent identifier based security for remote UEs in mobile networks are disclosed.

Specifically, new and improved techniques for permanent identifiers for applying intelligent security for remote UEs in mobile networks (e.g., a UE-to-Network Relay, also referred to herein simply as via relay, in a 5G network or a 4G/LTE network) that uses Proximity-based services (ProSe) are disclosed. In an example implementation, a security platform is deployed in the mobile network. The security platform is configured to inspect control signaling traffic (e.g., GTP control signaling traffic). More specifically, the security platform collects remote UE identities including, for example, IMSI, IMEI, MSISDN and IP address information, to provide visibility and enforcement capabilities for remote UEs that are not directly connected to the mobile network.

In some embodiments, a system/process/computer program product for permanent identifier based security for remote UEs in mobile networks includes monitoring network traffic in a core mobile network using a security platform to identify a Remote User Equipment (UE) that is attached to a core mobile network for mobile network communications; extracting one or more permanent identifiers from a Remote UE Report associated with the Remote UE using the security platform; and applying security enforcement to the Remote UE using the security platform based at least in part on the one or more permanent identifiers.

In one embodiment, the permanent identifier based security for remote UEs is provided for mobile networks that include a 4G/LTE network.

In one embodiment, the permanent identifier based security for remote UEs is provided for mobile networks that include a 5G network.

In one embodiment, the Remote UE is attached to the core mobile network via a ProSe UE-to-Network Relay.

In one embodiment, the one or more permanent identifiers includes subscriber identity and/or equipment identity information.

In one embodiment, the one or more permanent identifiers includes International Mobile Subscription Identity (IMSI), International Mobile Equipment Identity (IMEI), Mobile Station International Subscriber Directory Number (MSISDN), Network Access Identifier (NAI), and an Internet Protocol (IP) address.

In one embodiment, the security platform is configured to monitor one or more interfaces and to decode one or more of the following protocols in the core mobile network: GPRS Tunneling Protocol (GTP)-C, GTP-U, NAS, HTTP/2, and Next Generation Application Protocol (NGAP).

In one embodiment, the system recited in claim 1, the security platform is located in the core mobile network (e.g., a 4G/LTE mobile network, 5G mobile network, or later generation mobile network).

In one embodiment, the security platform is executed on a host entity in the core mobile network.

In one embodiment, the security platform is a virtual firewall executed on a host entity in the core mobile network.

In one embodiment, the security platform is configured with a plurality of security policies to apply network slice based security, subscriber identity based security, and/or equipment identity based security in the core mobile network.

In some embodiments, a system/process/computer program product for permanent identifier based security for remote UEs in mobile networks further includes applying application control to the network traffic of the Remote UE in the core mobile network based at least in part on the one or more permanent identifiers.

In some embodiments, a system/process/computer program product for permanent identifier based security for remote UEs in mobile networks further includes applying URL filtering to the network traffic of the Remote UE in the core mobile network based at least in part on the one or more permanent identifiers.

In some embodiments, a system/process/computer program product for permanent identifier based security for remote UEs in mobile networks further includes applying known and/or unknown threat identification and/or prevention to the network traffic of the Remote UE in the core mobile network based at least in part on the one or more permanent identifiers.

For example, the disclosed techniques for permanent identifier based security for remote UEs in mobile networks can provide the capability to apply identity (e.g., including International Mobile Subscription Identity (IMSI), International Mobile Equipment Identity (IMEI), Mobile Station International Subscriber Directory Number (MSISDN)) based security to UEs and IoT devices not directly connected (e.g., via Relay) to the 4G/LTE network or 5G network.

As another example, the disclosed techniques for permanent identifier based security for remote UEs in mobile networks can provide the capability to provide 4G subscriber/user and 4G equipment/device level known and unknown threat identification and prevention to UEs and IoT devices not directly connected (e.g., via relay) to the 4G/LTE network or 5G network.

As yet another example, the disclosed techniques for permanent identifier based security for remote UEs in mobile networks can provide the capability to provide 4G subscriber/user and 4G equipment/device level application security to UEs and IoT devices not connected directly (e.g., via relay) to the 4G/LTE network or 5G network.

As a further example, the disclosed techniques for permanent identifier based security for remote UEs in mobile networks can provide the capability to provide 4G subscriber/user and 4G equipment/device level URL filtering to UEs and IoT devices not connected directly (e.g., via relay) to the 4G/LTE network or 5G network.

These and other embodiments for permanent identifier based security for remote UEs in mobile networks will be further described below.

### Example System Embodiments for Permanent Identifier Based Security for Remote UEs in Mobile Networks

Various system embodiments for permanent identifier based security for remote UEs in mobile networks will now be further described below.

### Example System Embodiments for Permanent Identifier Based Security for Remote UEs in 4G/LTE Networks

In these example system embodiments for permanent identifier based security for remote UEs in 4G/LTE networks, various system embodiments for applying intelligent security for remote UEs in a 4G/LTE network use Proximity-based services (ProSe). Specifically, the security platform is deployed in the mobile network and configured to inspect GTP control signaling traffic to collect remote UE identities, including, for example, IMSI, IMEI, MSISDN and IP address information, to provide visibility and enforcement capabilities for remote UEs not connected directly to the mobile network, such as will now be further described below.

FIG. 1A is a protocol sequence diagram of a ProSe UE-to-Network Relay in a 4G/LTE mobile network environment in accordance with some embodiments. The ProSe UE-to-Network Relay is specified in the 3GPP Technical Specification 23.303 version 17.1.0, which is publicly available at https://www.etsi.org/deliver/etsi_ts/123300_123399/123303/17.01.00_60/ts_123303v170100p.p df.

Referring to FIG. 1A, a Remote UE 102 is in communication with a ProSe UE-to-NW Relay 104. After a connection is established between the Remote UE 102 and the ProSe UE-to-NW Relay 104 as shown in FIG. 1A, then, as shown at 120, a Remote UE Report is provided from the ProSe UE-to-NW Relay 104 to the Mobility Management Entity (MME) 108 (which traverses eNB 106 as shown). The Remote UE Report includes a Remote User ID and IP information.

In some embodiments, a security platform is located in the 4G/LTE mobile network environment to monitor one or more interfaces associated with MME 108 to extract the Remote User ID and IP information associated with the Remote UE Report communicated to the MME 108 as shown at 120, such as shown in and further described below with respect to FIG. 2A.

As also shown in FIG. 1A, at 122, the Remote UE Report is then provided from the MME 108 to a Serving Gateway (SGW) 110.

In some embodiments, a security platform is located in the 4G/LTE mobile network environment to monitor one or more interfaces associated with SGW 110 to extract the Remote User ID and IP information associated with the Remote UE Report communicated to the SGW 110 as shown at 122, such as shown in and further described below with respect to FIG. 2B.

As also shown in FIG. 1A, at 124, the Remote UE Report is then provided from the SGW 110 to a Packet Data Network Gateway (PGW) 112.

In some embodiments, a security platform is located in the 4G/LTE mobile network environment to monitor one or more interfaces associated with PGW 112 to extract the Remote User ID and IP information associated with the Remote UE Report communicated to the PGW 112 as shown at 122, such as shown in and further described below with respect to FIG. 2C.

Specifically, in an example implementation, the security platform extracts the above-identified information from the information element (IE) “Remote User ID” and “Remote User IP”. These IEs are inside the IE “Remote UE Context Connected”, which is inside the “Remote UE Report Notification message”. After extraction, the security platform then adds one or multiples entries of a UE IP and UE identity (e.g., IMSI related to this remote subscriber/user/IoT device) in a data store (e.g., a database) (not shown).

Also, when the Remote UE 102 is disconnected from the ProSe UE-to-NW Relay 104, the security platform deletes one or multiple entries of UE IP and UE identity (e.g., IMSI related to this remote subscriber, user, IoT device) in the data store referring to information, such as IMSI, IMEI, and/or MSISDN, in the IE “Remote User ID” which is present in IE “Remote UE Context Disconnected” in the “Remote UE Report Notification” message.

As such, the security platform can apply a security policy (e.g., including one or more rules, which can be based on UE IP and/or UE identity information) to the Relayed traffic 126 between the ProSe UE-to-NW Relay 104 and PGW 112 as shown in FIG. 1A, such as will be further described below.

FIG. 1B is a data structure diagram of a Remote User ID for a ProSe UE-to-Network Relay in a 4G/LTE mobile network environment in accordance with some embodiments. As shown in FIG. 1B, the Remote User ID data structure includes IMSI, MSISDN, and IMEI information.

FIG. 2A is a block diagram of a first example deployment architecture of a security platform in a 4G/LTE wireless network environment for permanent identifier based security for remote UEs in mobile networks in accordance with some embodiments. Specifically, FIG. 2A illustrates a first example deployment location of a security platform 202 (e.g., an NGFW or other security device/entity, such as similarly described above) in a 4G Core network 210 for performing the above-described techniques for permanent identifier based security for remote UEs in mobile networks, such as similarly described above with respect to FIGS. 1A and 1B. As also shown, the network traffic passes through the 4G Core network 210 to a Packet Data Network (PDN)/the Internet as shown at 220.

More specifically, in this example implementation, the security platform is located between the MME 108 and SGW 110 and monitors the S11 and S1-U interfaces for extracting information/parameters from the Remote UE Report as similarly described above and further described below. As such, the security platform can apply a security policy (e.g., including one or more rules, which can be based on UE IP and/or UE identity information) to the Relayed traffic (e.g., 126 as shown in FIG. 1A), such as will be further described below.

In addition, security platform 202 can also be in network communication with a Cloud Security 222 (e.g., a cloud security service, such as a commercially available cloud-based security service, such as the WildFire™ cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, the Cloud Security service can be utilized to provide the Security Platforms with dynamic prevention signatures for malware, DNS, URLs, CNC malware, and/or other malware as well as to receive malware samples for further security analysis. As will now be apparent, network traffic communications can be monitored/filtered using one or more security platforms for network traffic communications in various locations within the 4G/LTE network to facilitate enhanced security for 4G, 5G, and later versions of these mobile network environments, as will now be further described with respect to various embodiments.

FIG. 2B is a block diagram of a second example deployment architecture of a security platform in a 4G/LTE wireless network environment for permanent identifier based security for remote UEs in mobile networks in accordance with some embodiments. Specifically, FIG. 2B illustrates a second example deployment location of a security platform 202 (e.g., an NGFW or other security device/entity, such as similarly described above) in a 4G Core network 210 for performing the above-described techniques for permanent identifier based security for remote UEs in mobile networks, such as similarly described above with respect to FIGS. 1A and 1B. As also shown, the network traffic passes through the 4G Core network 210 to a Packet Data Network (PDN)/the Internet as shown at 220.

More specifically, in this example implementation, the security platform is located between the SGW 110 and PGW 112 and monitors the S5 interface for extracting information/parameters from the Remote UE Report as similarly described above and further described below. As such, the security platform can apply a security policy (e.g., including one or more rules, which can be based on UE IP and/or UE identity information) to the Relayed traffic (e.g., 126 as shown in FIG. 1A), such as will be further described below.

FIG. 2C is a block diagram of a third example deployment architecture of a security platform in a 4G/LTE wireless network environment for permanent identifier based security for remote UEs in mobile networks in accordance with some embodiments. Specifically, FIG. 2C illustrates a third example deployment location of a security platform 202 (e.g., an NGFW or other security device/entity, such as similarly described above) in a 4G Core network 210 for performing the above-described techniques for permanent identifier based security for remote UEs in mobile networks, such as similarly described above with respect to FIGS. 1A and 1B. As also shown, the network traffic passes through the 4G Core network 210 to a Packet Data Network (PDN)/the Internet as shown at 220.

More specifically, in this example implementation, the security platform is located between the PGW 112 and PDN/Internet 220 and monitors the S11 and SGI interfaces for extracting information/parameters from the Remote UE Report as similarly described above and further described below. As such, the security platform can apply a security policy (e.g., including one or more rules, which can be based on UE IP and/or UE identity information) to the Relayed traffic (e.g., 126 as shown in FIG. 1A), such as will be further described below.

In an example implementation, the security platform 202, which can be deployed in a 4G/LTE network in various locations, such as shown at FIGS. 2A, 2B, and 2C, is configured to monitor a GTPv2-C interface. Specifically, the security platform is configured to process the GTPv2-C message “Remote UE Report Notification” (e.g., as specified in section 7.2.26 in the 3GPP Technical Specification 29.274 version 17.9.0, which is publicly available at https://www.ctsi.org/deliver/etsi_ts/129200_129299/129274/17.09.00_60/ts_129274v170900p.p df) to extract the following information:

(1) Remote UE Context Connected IE that includes (a) the Remote User ID (e.g., the Remote User ID IE shall contain one IMSI identity and, if available, one IMEI identity and/or one MSISDN identity); and (b) the Remote UE IP; and

(2) Remote UE Context Disconnected IE that includes the Remote User ID (e.g., the Remote User ID IE shall contain one IMSI identity and, if available, one IMEI identity and/or one MSISDN identity) and Remote UE IP IE.

For example, the disclosed techniques for permanent identifier based security for remote UEs in mobile networks can provide the capability to apply identity (e.g., including International Mobile Subscription Identity (IMSI), International Mobile Equipment Identity (IMEI), and Mobile Station International Subscriber Directory Number (MSISDN)) based security to UEs and IoT devices not directly connected (e.g., via Relay) to the 4G/LTE network.

As another example, the disclosed techniques for permanent identifier based security for remote UEs in mobile networks can provide the capability to provide 4G subscriber/user and 4G equipment/device level known and unknown threat identification and prevention to UEs and IoT devices not directly connected (e.g., via relay) to the 4G/LTE network.

As yet another example, the disclosed techniques for permanent identifier based security for remote UEs in mobile networks can provide the capability to provide 4G subscriber/user and 4G equipment/device level application security to UEs and IoT devices not connected directly (e.g., via relay) to the 4G/LTE network.

As a further example, the disclosed techniques for permanent identifier based security for remote UEs in mobile networks can provide the capability to provide 4G subscriber/user and 4G equipment/device level URL filtering to UEs and IoT devices not connected directly (e.g., via relay) to the 4G/LTE network.

As will now be apparent to one of ordinary skill in the art, various other deployments of a security platform in a 4G/LTE wireless network environment can be similarly utilized for implementing the disclosed techniques for permanent identifier based security for remote UEs in mobile networks.

### Example System Embodiments for Permanent Identifier Based Security for Remote UEs in 5G Networks

In these example system embodiments for permanent identifier based security for remote UEs in 5G networks, various system embodiments for applying intelligent security for remote UEs in a 5G network use Proximity-based services (ProSe). Specifically, the security platform is deployed in the mobile network and configured to inspect signaling traffic (e.g., over NAS protocol, NGAP protocol, HTTP/2 protocol and various interfaces as will be further described below) to collect remote UE identities, including, for example, IMSI, IMEI, MSISDN, Network Access Identifier (NAI), and IP address information, to provide visibility and enforcement capabilities for remote UEs not connected directly to the mobile network, such as will now be further described below.

FIG. 3 is a protocol sequence diagram of a ProSe UE-to-Network Relay in a 5G mobile network environment with enhanced security in accordance with some embodiments. The ProSe Communication via 5G ProSe Layer-3 UE-to-Network Relay without N3IWF is specified in the 3GPP Technical Specification 23.304 version 17.8.0, which is publicly available at https://www.etsi.org/deliver/etsi_ts/123300_123399/123304/17.08.00_60/ts_123304v170800p.p df.

Referring to FIG. 3, a Remote UE 302 is in communication with a ProSe UE-to-NW Relay 304. After a connection is established between the Remote UE 302 and the Layer-3 UE-to-NW Relay 304 as shown in FIG. 3, then, as shown at 320, a Remote UE Report is provided from the Layer-3 UE-to-NW Relay 304 to the Session Management Function (SMF) 310 (which traverses NG-RAN 306 and Access and Mobility Management Function (AMF) 308 as shown). The Remote UE Report includes a Remote User ID and Remote UE information.

In some embodiments, a security platform is located in the 5G mobile network environment to monitor one or more interfaces associated with AMF 308 to extract the Remote User ID and Remote UE information associated with the Remote UE Report communicated from NG-RAN 306 to AMF 308 as shown at 320, such as shown in and further described below with respect to FIG. 4A.

As also shown at 320 in FIG. 3, the Remote UE Report is then provided from the AMF 308 to the SMF 310.

In some embodiments, a security platform is located in the 5G mobile network environment to monitor one or more interfaces associated with the AMF 308 and the SMF 310 to extract the Remote User ID and Remote UE information associated with the Remote UE Report as shown at 320, such as shown in and further described below with respect to FIG. 4B.

As also shown at 320 in FIG. 3, the Remote UE Report is provided from the NG-RAN 306 to the AMF 308.

In some embodiments, a security platform is located in the 5G mobile network environment to monitor one or more interfaces associated with the NG-RAN 306 and the AMF 308 to extract the Remote User ID and Remote UE information associated with the Remote UE Report as shown at 320, such as shown in and further described below with respect to FIG. 4C.

As also shown at 320 in FIG. 3, the Remote UE Report is then provided from the AMF 308 to the SMF 310.

In some embodiments, a security platform is located in the 5G mobile network environment to monitor one or more interfaces associated with the AMF 308 and the SMF 310 to extract the Remote User ID and Remote UE information associated with the Remote UE Report as shown at 320, such as shown in and further described below with respect to FIG. 4D.

Specifically, in an example implementation, the security platform extracts the above-identified information from the Remote UE Report message (e.g., as specified in section 8.3.19 in the 3GPP Technical Specification 24.501 version 17.14.0, which is publicly available at https://www.etsi.org/deliver/etsi_ts/124500_124599/124501/17.14.00_60/ts_124501v171400p.p df) and adds one or multiple entries of a UE IP and UE identity (e.g., IMSI related to this remote subscriber/user/IoT device) in a data store (e.g., a database) (not shown) from the IE “Remote UE Context Connected”.

Also, when the Remote UE 302 is disconnected from the Layer-3 UE-to-NW Relay 304, the security platform deletes one or multiple entries of UE IP and UE identity (e.g., IMSI related to this remote subscriber, user, IoT device) in the data store from the IE “Remote UE Context Disconnected”.

As such, the security platform can apply a security policy (e.g., including one or more rules, which can be based on UE IP and/or UE identity information) to the Relayed traffic 326 between the Layer-3 UE-to-NW Relay 304 and User Plane Function (UPF) 312 as shown in FIG. 3, such as will be further described below.

FIG. 4A is a block diagram of a first example deployment architecture of a security platform in a 5G wireless network environment for permanent identifier based security for remote UEs in mobile networks in accordance with some embodiments. Specifically, FIG. 4A illustrates a first example deployment location of a security platform 402 (e.g., an NGFW or other security device/entity, such as similarly described above) in a 5G Core network 410 for performing the above-described techniques for permanent identifier based security for remote UEs in mobile networks, such as similarly described above with respect to FIG. 3. As also shown, the network traffic passes through the 5G Core network 410 to a Packet Data Network (PDN)/the Internet as shown at 220.

More specifically, in this example implementation, the security platform is located between the 5G RAN 306 and the AMF 308 as well as the UPF 312 and monitors the N2 and N3 interfaces for extracting information/parameters from the Remote UE Report as similarly described above and further described below. As such, the security platform can apply a security policy (e.g., including one or more rules, which can be based on UE IP and/or UE identity information) to the Relayed traffic (e.g., as shown at 326 in FIG. 3), such as will be further described below.

In addition, security platform 402 can also be in network communication with a Cloud Security 222 (e.g., a cloud security service, such as a commercially available cloud-based security service, such as the WildFire™ cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, the Cloud Security service can be utilized to provide the Security Platforms with dynamic prevention signatures for malware, DNS, URLs, CNC malware, and/or other malware as well as to receive malware samples for further security analysis. As will now be apparent, network traffic communications can be monitored/filtered using one or more security platforms for network traffic communications in various locations within the 5G network to facilitate enhanced security for 4G, 5G, and later versions of these mobile network environments, as will now be further described with respect to various embodiments.

FIG. 4B is a block diagram of a second example deployment architecture of a security platform in a 5G wireless network environment for permanent identifier based security for remote UEs in mobile networks in accordance with some embodiments. Specifically, FIG. 4B illustrates a second example deployment location of a security platform 402 (e.g., an NGFW or other security device/entity, such as similarly described above) in a 5G Core network 410 for performing the above-described techniques for permanent identifier based security for remote UEs in mobile networks, such as similarly described above with respect to FIG. 3. As also shown, the network traffic passes through the 5G Core network 410 to a Packet Data Network (PDN)/the Internet as shown at 220.

More specifically, in this example implementation, the security platform is located between the 5G RAN 306 and the AMF 308 as well as the SMF 310 and monitors the N3 and N11 interfaces for extracting information/parameters from the Remote UE Report as similarly described above and further described below. As such, the security platform can apply a security policy (e.g., including one or more rules, which can be based on UE IP and/or UE identity information) to the Relayed traffic (e.g., as shown at 326 in FIG. 3), such as will be further described below.

FIG. 4C is a block diagram of a third example deployment architecture of a security platform in a 5G wireless network environment for permanent identifier based security for remote UEs in mobile networks in accordance with some embodiments. Specifically, FIG. 4C illustrates a third example deployment location of a security platform 402 (e.g., an NGFW or other security device/entity, such as similarly described above) in a 5G Core network 410 for performing the above-described techniques for permanent identifier based security for remote UEs in mobile networks, such as similarly described above with respect to FIG. 3. As also shown, the network traffic passes through the 5G Core network 410 to a Packet Data Network (PDN)/the Internet as shown at 220.

More specifically, in this example implementation, the security platform is located between the 5G RAN 306 and the AMF 308 as well as the UPF 312 and monitors the N2 and N6 interfaces for extracting information/parameters from the Remote UE Report as similarly described above and further described below. As such, the security platform can apply a security policy (e.g., including one or more rules, which can be based on UE IP and/or UE identity information) to the Relayed traffic (e.g., as shown at 326 in FIG. 3), such as will be further described below.

FIG. 4D is a block diagram of a fourth example deployment architecture of a security platform in a 5G wireless network environment for permanent identifier based security for remote UEs in mobile networks in accordance with some embodiments. Specifically, FIG. 4D illustrates a fourth example deployment location of a security platform 402 (e.g., an NGFW or other security device/entity, such as similarly described above) in a 5G Core network 410 for performing the above-described techniques for permanent identifier based security for remote UEs in mobile networks, such as similarly described above with respect to FIG. 3. As also shown, the network traffic passes through the 5G Core network 410 to a Packet Data Network (PDN)/the Internet as shown at 220.

More specifically, in this example implementation, the security platform is located between the AMF 308 and the SMF 310 as well as the UPF 312 and monitors the N11 and N6 interfaces for extracting information/parameters from the Remote UE Report as similarly described above and further described below. As such, the security platform can apply a security policy (e.g., including one or more rules, which can be based on UE IP and/or UE identity information) to the Relayed traffic (e.g., as shown at 326 in FIG. 3), such as will be further described below.

In an example implementation, the security platform 402, which can be deployed in a 5G network in various locations, such as shown at FIGS. 4A, 4B, 4C, and 4D, is configured to monitor traffic between the Layer-3 UE-to-NW Relay (e.g., as shown at 304 in FIG. 3) and the SMF (e.g., as shown at 310 in FIG. 3) at either the N2 interface (e.g., NGAP protocol) or the N11 interface (e.g., HTTP/2 protocol). Specifically, the security platform is configured to process the N1 SM NAS message “Remote UE Report” to extract the following information:

(1) Remote UE Context Connected message that includes (a) the Remote User ID (e.g., the Remote User ID IE shall contain one IMSI identity and, if available, one IMEI identity and/or one MSISDN identity); and (b) the Remote UE IP; and

(2) Remote UE Context Disconnected message that includes the Remote User ID (e.g., the Remote User ID IE shall contain one IMSI identity and, if available, one IMEI identity and/or one MSISDN identity).

For example, the disclosed techniques for permanent identifier based security for remote UEs in mobile networks can provide the capability to apply identity (e.g., including International Mobile Subscription Identity (IMSI), International Mobile Equipment Identity (IMEI), Mobile Station International Subscriber Directory Number (MSISDN)) based security to UEs and IoT devices not directly connected (e.g., via Relay) to the 5G network.

As another example, the disclosed techniques for permanent identifier based security for remote UEs in mobile networks can provide the capability to provide 5G subscriber/user and 5G equipment/device level known and unknown threat identification and prevention to UEs and IoT devices not directly connected (e.g., via relay) to the 5G network.

As yet another example, the disclosed techniques for permanent identifier based security for remote UEs in mobile networks can provide the capability to provide 5G subscriber/user and 5G equipment/device level application security to UEs and IoT devices not connected directly (e.g., via relay) to the 5G network.

As a further example, the disclosed techniques for permanent identifier based security for remote UEs in mobile networks can provide the capability to provide 5G subscriber/user and 5G equipment/device level URL filtering to UEs and IoT devices not connected directly (e.g., via relay) to the 5G network.

As will now be apparent to one of ordinary skill in the art, various other deployments of a security platform in a 5G wireless network environment can be similarly utilized for implementing the disclosed techniques for permanent identifier based security for remote UEs in mobile networks.

### Example Hardware Components of a Permanent Identifier Based Security for Remote UEs in Mobile Networks

FIG. 5 is a functional diagram of hardware components of a network device for permanent identifier based security for remote UEs in mobile networks in accordance with some embodiments. The example shown is a representation of physical/hardware components that can be included in network device 500 (e.g., an appliance, gateway, or server that can implement the security platform disclosed herein, such as shown at 202 in FIGS. 2A-C and 402 in FIGS. 4A-D). Specifically, network device 500 includes a high performance multi-core CPU 502 and RAM 504. Network device 500 also includes a storage 510 (e.g., one or more hard disks or solid state storage units), which can be used to store policy and other configuration information as well as signatures. In one embodiment, storage 510 stores certain information (e.g., IMSI, IMEI, MSISDN, NAI, and/or other parameters/information extracted from interfaces (e.g., SGi, S1-U, S5, S11, N2, N3, N6, N11, and/or other interfaces), parsed network traffic (e.g., GTP-C, GTPv2-C, NAS, NGAP, HTTP/2, and/or various messages, such as GTPv2-C messages “Remote UE Report Notification” and/or N1 SM NAS messages to extract the Remote UE Context Connected/Disconnected messages related information)) for implementing the disclosed security policy enforcement techniques for applying for permanent identifier based security for remote UEs (e.g., per network slice, subscriber-ID, equipment-ID, APN/DNN, location, RAT, and/or combinations thereof) in mobile networks using a security platform(s) as described herein.

In addition, network device 500 includes a Network Interface as shown at 514.

Network device 500 can also include one or more optional hardware accelerators. For example, network device 500 can include a cryptographic engine 506 configured to perform encryption and decryption operations, and one or more FPGAs 508 configured to perform signature matching, act as network processors, and/or perform other tasks.

As will now be apparent to one of ordinary skill in the art, the disclosed techniques for permanent identifier based security for remote UEs in mobile networks can be implemented using various hardware components of a network device (e.g., which can also include a Smart NIC, DPU, and/or other components with similar capabilities) for facilitating enhanced security for performing the disclosed techniques in mobile networks.

### Example Logical Components of a Network Device for Permanent Identifier Based Security for Remote UEs in Mobile Networks

FIG. 6 is a functional diagram of logical components of a network device for permanent identifier based security for remote UEs in mobile networks in accordance with some embodiments. The example shown is a representation of logical components that can be included in network device 600 (e.g., an appliance, gateway, or server that can implement the security platform disclosed herein, such as shown at 202 in FIGS. 2A-C and 402 in FIGS. 4A-D). As shown, network device 600 includes a management plane 602 and a data plane 604. In one embodiment, the management plane is responsible for managing user interactions, such as by providing a user interface for configuring policies and viewing log data. The data plane is responsible for managing data, such as by performing packet processing and session handling.

Suppose a mobile device attempts to access a resource (e.g., a remote web site/server, an MEC service, an IoT device, or another resource) using an encrypted session protocol, such as SSL. Network processor 606 is configured to monitor packets from the mobile device and provide the packets to data plane 604 for processing. Flow 608 identifies the packets as being part of a new session and creates a new session flow. Subsequent packets will be identified as belonging to the session based on a flow lookup. If applicable, SSL decryption is applied by SSL decryption engine 610 using various techniques as described herein. Otherwise, processing by SSL decryption engine 610 is omitted. Application identification (APP ID) module 612 is configured to determine what type of traffic the session involves (e.g., IP traffic and/or other network protocols of traffic, such as GTP-C traffic, GTP-U traffic, HTTP/2 traffic, NGAP traffic, etc., between various monitored interfaces as similarly described above with respect to FIGS. 1A-5) and to identify a user associated with the traffic flow (e.g., to identify a user-ID and an application-ID (APP-ID) as described herein). For example, APP ID 612 can recognize a GET request in the received data and conclude that the session requires an HTTP decoder 614. As another example, APP ID 612 can recognize GTP-U session messages carrying encapsulated IP traffic from UEs (e.g., over various interfaces, such as similarly described above with respect to FIGS. 2A-2C and 4A-4D) and conclude that the session requires a GTP-U decoder (e.g., to extract information exchanged in the GTP-U traffic session over various interfaces including various parameters, such as similarly described above with respect to FIGS. 2A-2C and 4A-4D). For each type of protocol, there exists a corresponding decoder 614. In one embodiment, the application identification is performed by an application identification module (e.g., APP ID component/engine), and a user identification is performed by another component/engine. Based on the determination made by APP ID 612, the packets are sent to an appropriate decoder 614. Decoder 614 is configured to assemble packets (e.g., which may be received out of order) into the correct order, perform tokenization, and extract out information (e.g., such to extract various information exchanged in GTP-U traffic over various interfaces as similarly described above and further described below). Decoder 614 also performs signature matching to determine what should happen to the packet. SSL encryption engine 616 performs SSL encryption using various techniques as described herein and the packets are then forwarded using a forward component 618 as shown. As also shown, policies 620 are received and stored in the management plane 602. In one embodiment, policy enforcement (e.g., policies can include one or more rules, which can be specified using domain and/or host/server names, and rules can apply one or more signatures or other matching criteria or heuristics, such as for security policy enforcement for subscriber/IP flows on service provider networks based on various extracted parameters/information from monitored GTP-C, GTP-U, HTTP/2, NGAP, IP traffic and/or DPI of such monitored mobile network traffic and/or other protocol(s) traffic, including various monitored core mobile network interfaces, such as SGi, S1-U, S5, S11, N2, N3, N6, N11, and/or other interfaces as similarly described above with respect to FIGS. 1A-5) is applied as described herein with respect to various embodiments based on the monitored, decrypted, identified, and decoded session traffic flows.

As also shown in FIG. 6, an interface (I/F) communicator 622 is also provided for security platform manager communications. In some cases, network communications of other network elements on the service provider network are monitored using network device 600, and data plane 604 supports decoding of such communications (e.g., network device 600, including I/F communicator 622 and decoder 614, can be configured to monitor and/or communicate on, for example, reference point interfaces such as SGi, S1-U, S5, S11, N2, N3, N6, N11, and/or other interfaces where wired and wireless network traffic flow exists). As such, network device 600 including I/F communicator 622 can be used to implement the disclosed techniques for applying permanent identifier based security for remote UEs in mobile networks as described above and as will be further described below.

Various example uses cases for permanent identifier based security for remote UEs in mobile networks will be described below.

### Example Use Cases for Permanent Identifier Based Security for Remote UEs in Mobile Networks

Various example uses cases for permanent identifier based security for remote UEs in mobile networks will now be described below.

As a first example use case, the disclosed techniques for permanent identifier based security for remote UEs in mobile networks can be applied to facilitate an enterprise customer to apply advanced L7 security enforcement for critical infrastructure devices connected via relay to a 4G/LTE or 5G network.

As a second example use case, the disclosed techniques for permanent identifier based security for remote UEs in mobile networks can be applied to facilitate a service provider (e.g., a service provider of mobile networks) for providing advanced threat prevention services to their enterprise 4G/LTE or 5G customers (e.g., which may have a majority of UEs connected via relay).

Additional example process embodiments for permanent identifier based security for remote UEs in mobile networks will be further described below.

### Example Process Embodiments for Permanent Identifier Based Security for Remote UEs in Mobile Networks

Various process embodiments for permanent identifier based security for remote UEs in mobile networks will now be further described below.

FIG. 7 is a flow diagram of a process for permanent identifier based security for remote UEs in mobile networks in accordance with some embodiments. In some embodiments, a process as shown in FIG. 7 is performed by the security platform and techniques as similarly described above including the embodiments described above with respect to FIGS. 1A-6. In one embodiment, the process is performed by data appliance 500 as described above with respect to FIG. 5, network device 600 as described above with respect to FIG. 6, a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 702, monitoring network traffic in a core mobile network using a security platform to identify a Remote User Equipment (UE) that attached to a core mobile network for mobile network communications is performed. For example, the security platform can be located in the core mobile network (e.g., a 4G/LTE, 5G, or later generation mobile network), such as similarly described above.

At 704, extracting one or more permanent identifiers from a Remote UE Report associated with the Remote UE using the security platform is performed. For example, the one or more permanent identifiers can include International Mobile Subscription Identity (IMSI), International Mobile Equipment Identity (IMEI), Mobile Station International Subscriber Directory Number (MSISDN), and an Internet Protocol (IP) address, such as similarly described above with respect to FIGS. 1A-4D. Also, the security platform can be configured to monitor one or more interfaces and to decode one or more of the following protocols in the core mobile network: GPRS Tunneling Protocol (GTP)-C, GTP-U, NAS, HTTP/2, and Next Generation Application Protocol (NGAP), such as similarly described above with respect to FIGS. 1A-6.

At 706, applying security enforcement to the Remote UE using the security platform based at least in part on the one or more permanent identifiers is performed. For example, the security platform can be configured to enforce a security policy (e.g., including one or more rules).

In some embodiments, a system/process/computer program product for permanent identifier based security for remote UEs in mobile networks further includes applying application control to the network traffic of the Remote UE in the core mobile network based at least in part on the one or more permanent identifiers.

In some embodiments, a system/process/computer program product for permanent identifier based security for remote UEs in mobile networks further includes applying URL filtering to the network traffic of the Remote UE in the core mobile network based at least in part on the one or more permanent identifiers.

In some embodiments, a system/process/computer program product for permanent identifier based security for remote UEs in mobile networks further includes applying known and/or unknown threat identification and/or prevention to the network traffic of the Remote UE in the core mobile network based at least in part on the one or more permanent identifiers.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor network traffic in a core mobile network using a security platform to identify a Remote User Equipment (UE) that attached to the core mobile network for mobile network communications;
extract one or more permanent identifiers from a Remote UE Report associated with the Remote UE using the security platform; and
apply security enforcement to the Remote UE using the security platform based at least in part on the one or more permanent identifiers; and
a memory coupled to the processor and configured to provide the processor with instructions.

2. The system recited in claim 1, wherein the Remote UE is attached to the core mobile network via a ProSe UE-to-Network Relay.

3. The system recited in claim 1, wherein the one or more permanent identifiers includes subscriber identity and/or equipment identity information.

4. The system recited in claim 1, wherein the one or more permanent identifiers includes International Mobile Subscription Identity (IMSI), International Mobile Equipment Identity (IMEI), Mobile Station International Subscriber Directory Number (MSISDN), Network Access Identifier (NAI), and an Internet Protocol (IP) address.

5. The system recited in claim 1, wherein the security platform is configured to monitor one or more interfaces and to decode one or more of the following protocols in the core mobile network: GPRS Tunneling Protocol (GTP)-C, GTP-U, NAS, HTTP/2, and Next Generation Application Protocol (NGAP).

6. The system recited in claim 1, wherein the security platform is located in the core mobile network.

7. The system recited in claim 1, wherein the security platform is located in the core mobile network, and wherein the mobile network includes a 4G/LTE mobile network.

8. The system recited in claim 1, wherein the security platform is located in the core mobile network, and wherein the mobile network includes a 5G mobile network.

9. The system recited in claim 1, wherein the security platform is executed on a host entity in the core mobile network.

10. The system recited in claim 1, wherein the security platform is a virtual firewall executed on a host entity in the core mobile network.

11. The system recited in claim 1, wherein the security platform is configured with a plurality of security policies to apply network slice based security, subscriber identity based security, and/or equipment identity based security in the core mobile network.

12. The system recited in claim 1, wherein the processor is further configured to:
apply application control to the network traffic of the Remote UE in the core mobile network based at least in part on the one or more permanent identifiers.

13. The system recited in claim 1, wherein the processor is further configured to:
apply URL filtering to the network traffic of the Remote UE in the core mobile network based at least in part on the one or more permanent identifiers.

14. The system recited in claim 1, wherein the processor is further configured to:
apply known and/or unknown threat identification and/or prevention to the network traffic of the Remote UE in the core mobile network based at least in part on the one or more permanent identifiers.

15. A method, comprising:
monitoring network traffic in a core mobile network using a security platform to identify a Remote User Equipment (UE) that attached to the core mobile network for mobile network communications;
extracting one or more permanent identifiers from a Remote UE Report associated with the Remote UE using the security platform; and
applying security enforcement to the Remote UE using the security platform based at least in part on the one or more permanent identifiers.

16. The method of claim 15, wherein the Remote UE is attached to the core mobile network via a ProSe UE-to-Network Relay.

17. The method of claim 15, wherein the one or more permanent identifiers includes subscriber identity and/or equipment identity information.

18. The method of claim 15, wherein the one or more permanent identifiers includes International Mobile Subscription Identity (IMSI), International Mobile Equipment Identity (IMEI), Mobile Station International Subscriber Directory Number (MSISDN), Network Access Identifier (NAI), and an Internet Protocol (IP) address.

19. The method of claim 15, wherein the security platform is configured to monitor one or more interfaces and to decode one or more of the following protocols in the core mobile network: GPRS Tunneling Protocol (GTP)-C, GTP-U, NAS, HTTP/2, and Next Generation Application Protocol (NGAP).

20. A computer program product, the computer program product being embodied in a non-transitory computer readable storage medium and comprising computer instructions for:
monitoring network traffic in a core mobile network using a security platform to identify a Remote User Equipment (UE) that attached to the core mobile network for mobile network communications;
extracting one or more permanent identifiers from a Remote UE Report associated with the Remote UE using the security platform; and
applying security enforcement to the Remote UE using the security platform based at least in part on the one or more permanent identifiers.
